(19) United States
(12) Patent Application Publication
(10) Pub. No.: US 2019/0349492 A1
(43) Pub. Date: Nov. 14, 2019

(54) IMAGE FORMING APPARATUS EQUIPPED WITH OPERATING UNIT, CONTROL METHOD THEREFOR, AND STORAGE MEDIUM

(71) Applicant: CANON KABUSHIKI KAISHA, Tokyo (JP)

(72) Inventor: Yoko Takenaka, Kashiwa-shi (JP)

(21) Appl. No.: 16/398,364

(22) Filed: Apr. 30, 2019

(30) Foreign Application Priority Data
May 14, 2018 (JP) 2018-093116

(51) Int. Cl. H04N 1/00; G06F 3/12

(52) U.S. Cl. CPC H04N 1/00477; G06F 3/1259; H04N 1/00514; H04N 1/00466; G06F 3/1207

(57) ABSTRACT

An image forming apparatus which is capable of effectively using waiting time of a user who directly operates the image forming apparatus. The image forming apparatus is equipped with a display unit and an operating unit. A content registered in advance is obtained, and control is provided to display the content on the display unit. When a specific event relating to operation on the operating unit by a user has occurred, the content is displayed on the display unit.

### BACKGROUND OF THE INVENTION

### Field of the Invention

The present invention relates to an image forming apparatus, a control method therefor, and a storage medium storage.

### Description of the Related Art

Digital signage that dispatches information in every place such as a store or an office using a display connected to a network is widely used. For example, when an MFP which is an image forming apparatus receives print data from a client terminal, a content such as an advertisement is displayed on a monitor of the client terminal, which sent print data, while the MFP is printing the print data (see, for example, Japanese Laid-Open Patent Publication (Kokai) No. 2002-157101). This enables a user to make good use of waiting time without getting bored until printing is completed.

However, according to the above technique disclosed in Japanese Laid-Open Patent Publication (Kokai) No. 2002-157101, the content is not displayed on an operating unit of the MFP although it is displayed on the monitor of the client terminal, and therefore, waiting time of a user who directly operates the MFP cannot be effectively used.

### SUMMARY OF THE INVENTION

The present invention provides an image forming apparatus which is capable of effectively using waiting time of a user who directly operates the image forming apparatus, a control method therefor, and a storage medium.

Accordingly, the present invention provides an image forming apparatus equipped with a display unit and an operating unit, comprising an obtaining unit configured to obtain a content registered in advance, and a display control unit configured to provide control to display the content on the display unit, wherein the display control unit displays the content on the display unit when a specific event relating to operation on the operating unit by a user has occurred.

According to the present invention, waiting time of a user who directly operates the image forming apparatus is effectively used.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of a communication system including an MFP which is an image forming apparatus according to an embodiment of the present invention.

FIG. 2 is a block diagram schematically showing a hardware arrangement of the MFP in FIG. 1.

FIG. 3 is a block diagram schematically showing a software arrangement of the MFP in FIG. 1.

FIGS. 4A and 4B are views showing examples of screens which are displayed on a client PC in FIG. 1.

FIG. 5 is a view showing an example of a signage setting screen which is displayed on the client PC in FIG. 1.

FIG. 6 is a view showing an example of a content setting management table in FIG. 3.

FIGS. 7A to 7D are views showing examples of setting screens which are displayed on an operating unit in FIG. 2.

FIGS. 8A and 8B are views useful in explaining screen transition on the operating unit according to a first display setting.

FIGS. 9A and 9B are views useful in explaining screen transition on the operating unit according to a second display setting.

FIG. 10 is a view useful in explaining screen transition on the operating unit according to a third display setting.

FIG. 11 is a view showing an example of Web contents which are displayed on the operating unit in FIG. 2

FIGS. 12A and 12B are views useful in explaining screen transition on the operating unit according to a fourth display setting.

FIGS. 13A and 13B are views useful in explaining screen transition on the operating unit according to a fifth display setting.

FIGS. 14A and 14B are views useful in explaining screen transition on the operating unit according to a sixth display setting.

FIGS. 15A and 15B are views useful in explaining screen transition on the operating unit according to a seventh display setting.

FIG. 16 is a view useful in explaining screen transition on the operating unit according to an eighth display setting.

FIGS. 17A and 17B are flowcharts showing the procedure of a content display process which is carried out by the MFP in FIG. 1.

FIG. 18 is a view showing an example of a signage setting screen which is displayed on the client PC in FIG. 1.

FIGS. 19A and 19B are flowcharts showing a variation of the procedure of the content display process in FIGS. 17A and 17B.

FIG. 20 is a flowchart showing the procedure of a predicted printing time period calculation process in the step S1901 in FIGS. 19A and 19B.

### DESCRIPTION OF THE EMBODIMENTS

An embodiment of the present invention will now be described in detail with reference to the accompanying drawings. It should be noted that in the present embodiment described below, the present invention is applied to an MFP which is an image forming apparatus, but the present invention is not limited to the MFP. For example, the present invention may be applied to information processing apparatuses equipped with an image viewer, such as a personal computer, a PDA, a cell phone, a fax, a camera, and a video camera.

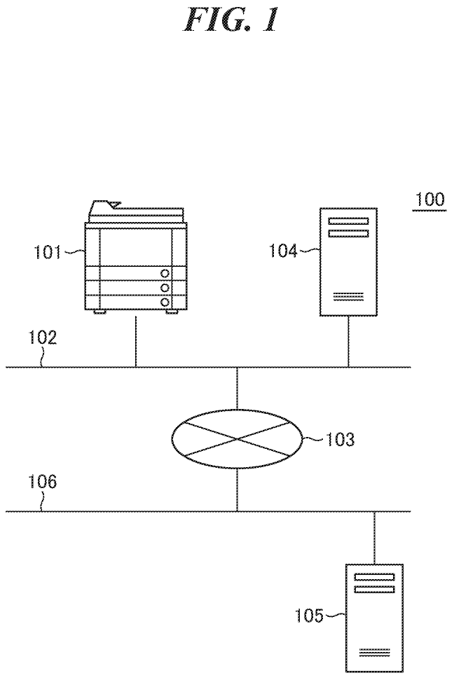

FIG. 1 is a block diagram schematically showing an arrangement of a communication system 100 including the MFP 101 which is an image forming apparatus according to the embodiment of the present invention. Referring to FIG. 1, the communication system 100 has the MFP 101, a client PC 104, and a content server 105. The MFP 101 is connected to the Internet 103 via a LAN 102. The client PC 104 is connected to the MFP 101 via the LAN 102. The content server 105 is connected to the Internet 103 via a LAN 106.

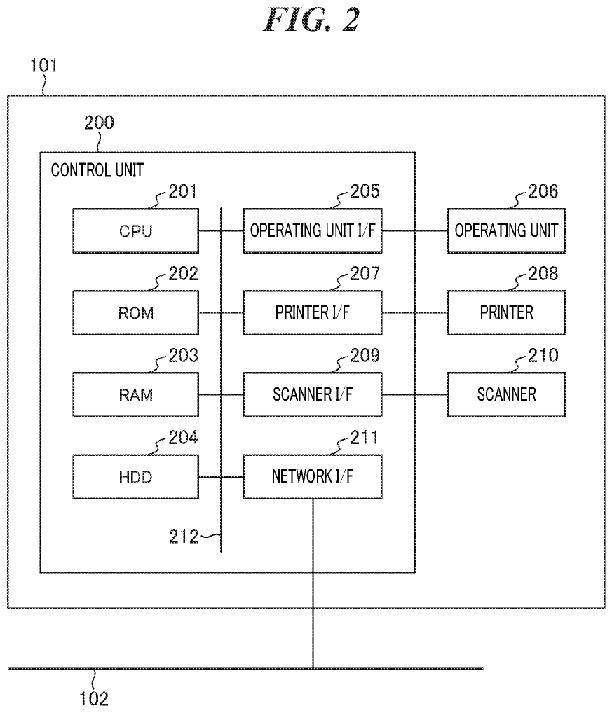

The MFP 101 has a plurality of functions such as a copying function, a scanning function, a printing function, a scan-and-send function, a scan-and-save function, a saved file using function, and a browser function. The copying function is a function of reading an original placed on an original platen glass (not shown) of the MFP 101, generating image data, and printing the image data. The printing function is a function of performing printing based on print data received from the client PC 104 or the like by the MFP 101. The scan-and-send function is a function of sending the image data, which is generated by the MFP 101 reading the original, to an external apparatus. The scan-and-save function is a function of saving, in an HDD 204 in FIG. 2, to be described later, the image data generated by the MFP 101 reading the original. The saved file using function is a function of printing the image data saved in the HDD 204 in FIG. 2, to be described later, of the MFP 101 or sending the image data from the MFP 101 to an external apparatus. The browser function is a function of viewing, printing, and saving data on a Web server (not shown) via a Web browser (not shown).

The client PC 104 generates print data in accordance with an instruction from a user. The print data includes a sheet size, the number of sheets to be printed, a print starting time, and so forth. The client PC 104 sends the generated print data to the MFP 101. The content server 105 stores various contents, and in response to requests from the MFP 101, sends the contents to the MFP 101. The contents are data viewable on the Web browser and are, for example, image files such as HTML, JPEG, GIF, and BMP, text data, and video files. It should be noted that for the sake of simplification in the following description of the present embodiment, the communication system 100 is equipped with one MFP 101, one client PC 104, and one content server 105, but the communication system 100 may be equipped with a plurality of MFPs 101, client PCs 104, and content servers 105. Moreover, in the present embodiment, not the content server 105 but the HDD 204 in FIG. 2, to be described later, of the MFP 101 may store the contents.

FIG. 2 is a block diagram schematically showing a hardware arrangement of the MFP 101 in FIG. 1. Referring to FIG. 2, the MFP 101 is equipped with a control unit 200, an operating unit 206, a printer 208, and a scanner 210. The control unit 200 is connected to the operating unit 206, the printer 208, and the scanner 210. The control unit 200 is also equipped with a CPU 201, a ROM 202, a RAM 203, an HDD 204, an operating unit I/F 205, a printer I/F 207, a scanner I/F 209, and a network I/F 211. The CPU 201, the ROM 202, the RAM 203, the HDD 204, the operating unit I/F 205, the printer I/F 207, the scanner I/F 209, and the network O/F 211 are connected to one another via a system bus 212.

The control unit 200 controls operation of the entire MFP 101. The CPU 201 reads out control programs stored in the ROM 202 to control reading, transmission, and so forth. The ROM 202, which is a boot ROM, stores a system boot program. The RAM 203 is used as a main work memory for the CPU 201 and also used as a temporary storage area for each piece of data. The HDD 204 stores image data, programs, and information tables. The HDD 204 also stores contents to be displayed on the operating unit 206. The operating unit I/F 205 is an interface for connecting the operating unit 206 to the control unit 200. The operating unit 206 has a liquid crystal display with a touch panel function and a keyboard.

The printer I/F 207 is an interface for connecting the printer 208 to the control unit 200. The printer 208 obtains image data, which is transferred from the control unit 200, via the printer I/F 207 and prints the obtained image data on a sheet. The scanner I/F 209 is an interface for connecting the scanner 210 to the control unit 200. The scanner 210 reads image data off an original, generates image data, and transfers the image data to the control unit 200 via the scanner I/F 209. The network I/F 211 is an interface for connecting the control unit 200 to the LAN 102. The network I/F 211 carries out data communications with external apparatuses such as the client PC 104 and the content server 105.

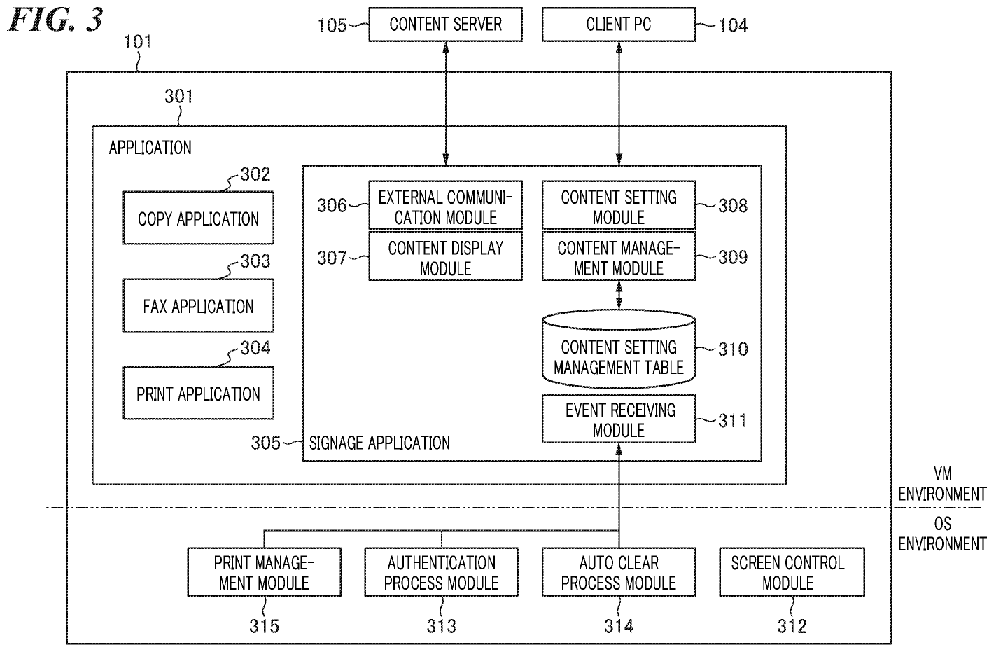

FIG. 3 is a block diagram schematically showing a software arrangement of the MFP 101 in FIG. 1. Referring to FIG. 3, the MFP 101 has an application 301, a screen control module 312, an authentication process module 313, an auto clear process module 314, and a print management module 315 as software modules. The MFP 101 also has an OS environment (first operating environment) and a VM (virtual machine) environment (second operating environment) which are operating environments for the software modules. The OS environment is an operating environment for running software modules preinstalled in the MFP 101. In the present embodiment, the screen control module 312, the authentication process module 313, the auto clear process module 314, and the print management module 315 run in the OS environment. The VM environment is an operating environment for running software modules preinstalled in the MFP 101 and expansion application modules installed in the MFP 101. In the present embodiment, the application 301 runs in the VM environment. It should be noted that processes by the software modules described above are implemented by the CPU 201 executing programs stored in the ROM 202 or the HDD 204.

The application 301 has at least a copy application 302, a fax application 303, a print application 304, and a signage application 305 as modules. It should be noted that the application 301 may have additional modules other than the modules mentioned above.

The copy application 302 carries out an original copying process using the scanner 210 and the printer 208. The copy application 302 also carries out a process to copy a large number of originals by sequential reading using the HDD 204. The copy application 302 also performs cascade copying by sending scanned-off image data to another MFP (not shown) connected to the LAN 102. The fax application 303 controls a fax I/F (not shown) to send and receive G3 faxes and G4 faxes using a telephone line (not shown). The fax application 303 also transfers data, which is received by fax, via e-mail or the like using a transfer function. The fax application 303 also performs Internet faxing by sending and receiving faxes using the Internet 103.

Upon receiving a printing instruction issued using the operating unit 206, the print application 304 requests the print management module 315 to perform printing. Also, upon receiving print data described in PDL such as PostScript or LIPS from the client PC 105, the print application 304 requests the print management module 315 to perform printing based on the print data. It should be noted that LIPS is an abbreviation for LBP image processing. PDL is an abbreviation for page-description language. The print application 304 directly receives application data such as PDL (Portable Document Format) from an external apparatus without using a printer driver and prints the application data.

The signage application 305 controls display of contents. The signage application 305 has an external communication module 306, a content display module 307, a content setting module 308, a content management module 309, a content setting management table 310, and an event receiving module 311.

The external communication module 306 carries out communications with the content server 105 to obtain contents from the content server 105. The external communication module 306 carries out communications with the content server 105 using communication protocols such as SMB (Sever Message Block), WebDAV (Web-based Distributed Authoring and Versioning), and HTTP (Hypertext Transfer Protocol). It should be noted that the external communication module 306 can use other communication protocols such as an electronic mail and a file transfer protocol (FTP) as well as the communication protocols mentioned above.

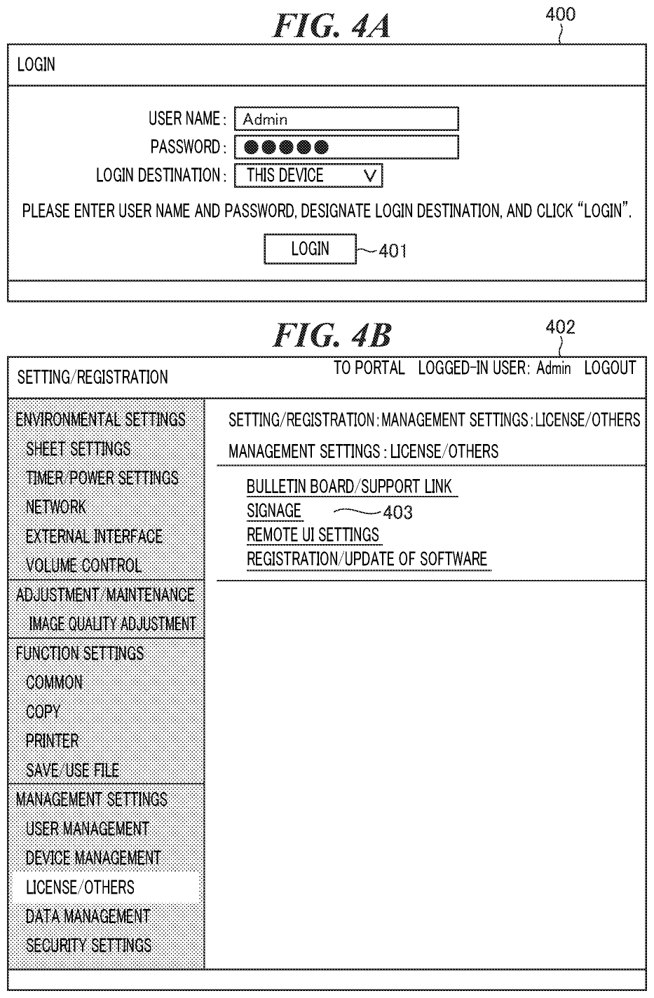

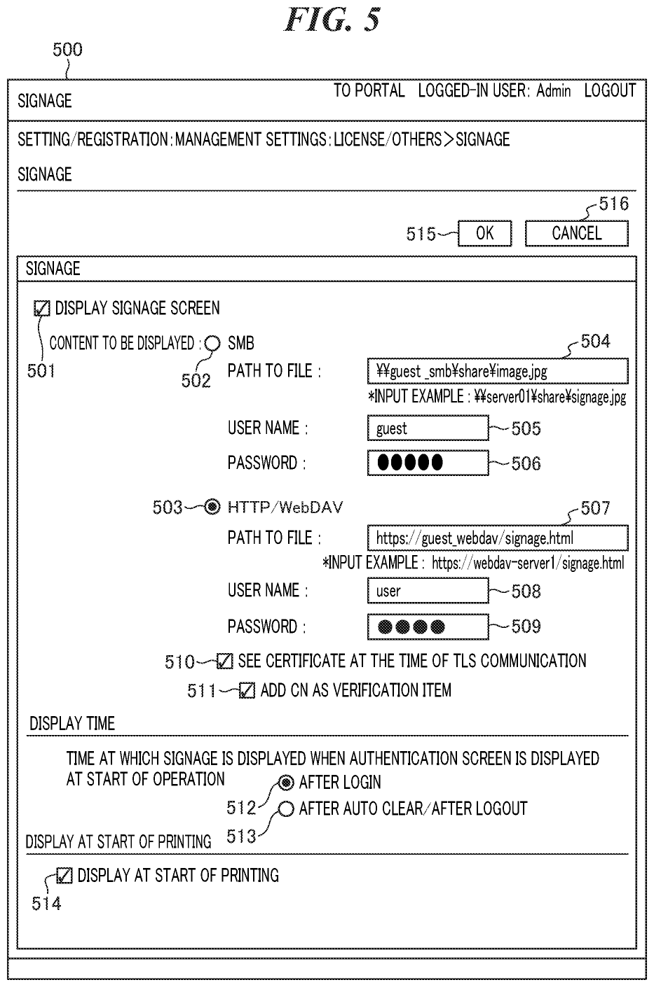

The content display module 307 reads contents stored in the content server 105 or the HDD 204 into the RAM 203 and outputs the contents to the operating unit 206. The content setting module 308 sets a content to be displayed on the operating unit 206. In the present embodiment, a content to be displayed on the operating unit 206 can be designated from the client PC 104. When the client PC 104 accesses a Web server (not shown) of the MFP 101 using the Web browser of the client PC 104, a login screen 400 in FIG. 4A is displayed on the client PC 104. When, on the login screen 400, authentication information such as a user name and a password is input, and a login button 401 is selected, the authentication process module 313 performs user authentication based on the authentication information. Whether or not the authentication information input on the login screen 400 matches authentication information on a signage setting administrator registered in advance is determined in the user authentication. When the user authentication is successful, a setting registration screen 402 in FIG. 4B is displayed on the client PC 104. It should be noted that in the description of the present embodiment, it is assumed that when the user authentication is successful, the display on the client PC 104 switches from the login screen 400 to the setting registration screen 402 but may switch from the login screen 400 to the setting registration screen 402 by way of another screen. On the setting registration screen 402, when the user selects a setting item 403, a signage setting screen 500 in FIG. 5 is displayed on the client PC 104.

The signage setting screen 500 is a screen for configuring settings on a content to be displayed on the operating unit 206. Namely, in the present embodiment, only a specific user who has successfully been authenticated, and more specifically, a signage setting administrator is allowed to configure settings on a content to be displayed on the operating unit 206. The signage setting screen 500 has a screen display checkbox 501, content setting buttons 502 and 503, text boxes 504 to 509, encryption checkboxes 510 and 511, display timing setting buttons 512 and 513, a checkbox 514, an OK button 515, and a cancel button 516.

The screen display checkbox 501 is a setting item for selecting whether or not to display a content on the operating unit 206. When the screen display checkbox 501 is not selected, it is impossible to input the other setting items on the signage setting screen 500. On the other hand, when the screen display checkbox 501 is selected, it is possible to input the other setting items on the signage setting screen 500.

The content setting buttons 502 and 503 are radio buttons for setting a communication protocol to be used between the external communication module 306 and the content server 105. The user is allowed to select one of the content setting buttons 502 and 503. When the content setting button 502 is selected, SMB is set as the communication protocol, and setting items as to SMB, and more specifically, it is possible to input data into the text boxes 504 to 506. When the content setting button 503 is selected, HTTP/WebDAV is set as the communication protocol, and setting items as to HTTP/WebDAV, and more specifically, it is possible to input data into the text boxes 507 to 509 and mark the encryption checkboxes 510 and 511.

A content path, which indicates name and a storage location of a content to be displayed when SMB is set as the communication protocol, is set in the text box 504. In the text box 504, a character string in which a computer name, a folder name, and a file name are separated by ¥ (a mark for Yen) and \ (a backward slash) is set as the content path. In the text box 504, a file stored in the HDD 204 or a file stored in the content server 105 is set as a content. A user name for use in accessing the content set in the text box 504 is set in the text box 505. A password for use in accessing the content set in the text box 504 is set in the text box 506.

A content path, which indicates a name and a storage location of a content to be displayed when HTTP/WebDAV is set as the communication protocol, is set in the text box 507. In the text box 507, a character string in which a computer name, a folder name, and a file name are separated by/(a slash) is set as the content path. In the text box 507, a file stored in the HDD 204 or a file stored in the content server 105 is set as a content as with the text box 504. A user name for use in accessing the content set in the text box 507 is set in the text box 508. A password for use in accessing the content set in the text box 507 is set in the text box 509. The encryption checkboxes 510 and 511 are setting items as to an encrypted communication, and they can be marked only when the content setting button 503 is selected.

The display timing setting buttons 512 and 513 are radio buttons for setting a time at which the content is displayed on the operating unit 206. The user is allowed to select one of the display timing setting buttons 512 and 513. When the display timing setting button 512 is selected, the content set in the text box 504 or 507 is displayed on the operating unit 206 when the user logs into the MFP 101. When the display timing setting button 513 is selected, the content set in the text box 504 or 507 is displayed on the operating unit 206 when the MFP 101 does auto clear, to be described later, or the user logs out of the MFP 101.

The checkbox 514 is a setting item for selecting whether or not to display a content on the operating unit 206 while printing is being performed. When the checkbox 514 is selected, the content is displayed on the operating unit 206 while printing is being performed. When the checkbox 514 is not selected, the content is not displayed on the operating unit 206 while printing is being performed. The OK button 515 is a button for recording, in the content setting management table 310, setting values of the respective setting items on the signage setting screen 500. When the user presses the OK button 515, the setting values of the respective setting items on the signage setting screen 500 are recorded in the content setting management table 310. Also, the display on the client PC 104 switches from the signage setting screen 500 to the setting registration screen 402. The cancel button 516 is a button for switching the display on the client PC 104 from the signage setting screen 500 to the setting registration screen 402 without recording the setting values of the respective setting items on the signage setting screen 500 in the content setting management table 310. It should be noted that although in the present embodiment described above, settings on a content to be displayed on the operating unit 206 are configured from the client PC 104, the settings may be configured from the operating unit 206 of the MFP 101.

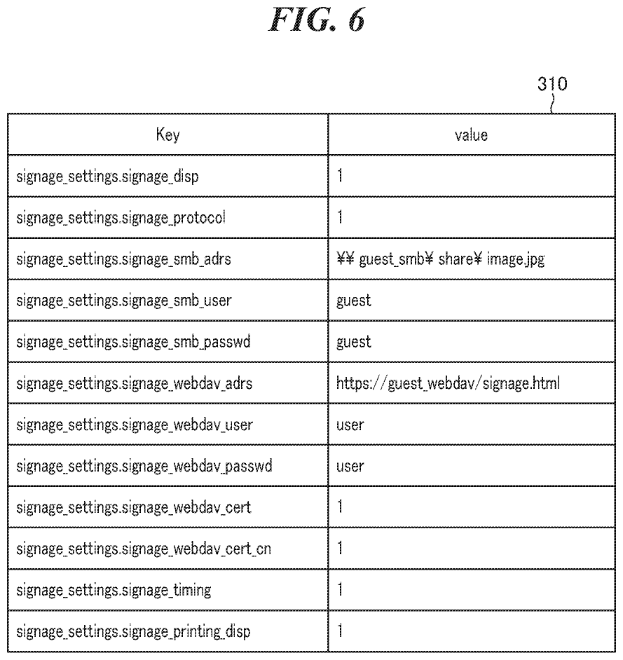

Referring again to FIG. 3, the content management module 309 records the setting values configured on the signage setting screen 500 in the content setting management table 310. The content management module 309 also obtains the setting values recorded in the content setting management table 310 and notifies the content display module 307 of the obtained setting values. The content setting management table 310 is, as shown in FIG. 6, a management table for managing each of the setting values configured on the signage setting screen 500. The content setting management table 310 is stored in the HDD 204 or the content server 105. The event receiving module 311 receives notifications indicating occurrence of events (hereafter referred to as “event notifications”) from the authentication process module 313, the auto clear process module 314, and the print management module 315. It should be noted that the event receiving module 311 can receive event notifications from other modules, not shown, as well.

The screen control module 312 controls display on the operating unit 206. The authentication process module 313 performs user authentication based on authentication information input on the operating unit 206. The authentication process module 313 carries out a login process when the user authentication is successful. This enables a user who has input the authentication information to use the functions of the MFP 101. After that, upon receiving a logout instruction via the operating unit 206, the authentication process module 313 carries out a logout process. The authentication process module 313 notifies the event receiving module 311 of occurrence of a login event for carrying out the login process and also notifies the event receiving module 311 of occurrence of a logout event for carrying out the logout process.

The auto clear process module 314 carries out an auto clear process when the user has not operated the operating unit 206 for a predetermined time period (hereafter referred to as “the auto clear transition time period”). The auto clear process is a process in which setting values on and a setting state of a screen displayed on the operating unit 206 are reset, and more specifically, the setting values and the setting state are cleared and reset to defaults. For example, when the user leaves the MFP 101 while configuring a copy screen (not shown) for making settings on copying, and the auto clear transition time period has elapsed, setting values configured halfway are cleared and reset to default setting values. The auto clear function prevents settings made by a user who used the MFP 101 last time from being taken over against user's will and prevents a user who uses the MFP 101 next time from viewing details of settings that are not supposed to be disclosed.

In response to the auto clear process being carried out, the auto clear process module 314 notifies the event receiving module 311 of occurrence of an auto clear event. In response to the auto clear process being carried out, the auto clear process module 314 also carries out a logout process for the logged-in user. It should be noted that in the present embodiment, the user is allowed to set the auto clear transition time period. The user is also allowed to set a screen to which the display on the operating unit 206 is to switch at the time of the auto clear process. When an initial screen is set as the screen to which the display on the operating unit 206 is to switch at the time of the auto clear process, the display on the operating unit 206 switches the initial screen in response to the auto clear process being carried out. The initial screen is a screen set in advance by the user as a screen to be displayed at the time of startup. Examples of the initial screen include a main menu screen for selecting a function from among a plurality of functions (applications and functions) which the MFP 101 has and application screens for the respective functions. In the following description, it is assumed that the main menu screen is set as the initial screen. The print management module 315 performs an operation to start a print job and also notifies the event receiving module 311 that the print job has started.

For example, upon receiving a print starting instruction, the print application 304 (instruction receiving application) running in the VM environment requests the print management module 315 running in the OS environment to perform printing. The print management module 315 requested to perform printing by the print application 304 starts printing and also notifies the event receiving module 311 of the signage application 305 (content display control application), running in the VM environment, of a content display request. The signage application 305 that has received the content display request provides control to cause the content display module 307 to display a Web content 1100 on the operating unit 206. Thus, in the present embodiment, not the print application 304 that has received the instruction to start printing but the signage application 305 controls display of contents. Namely, display of contents is integratedly controlled by the signage application 305. This eliminates the necessity for the applications such as the copy application 302 and the print application 304 to build control programs for display of contents.

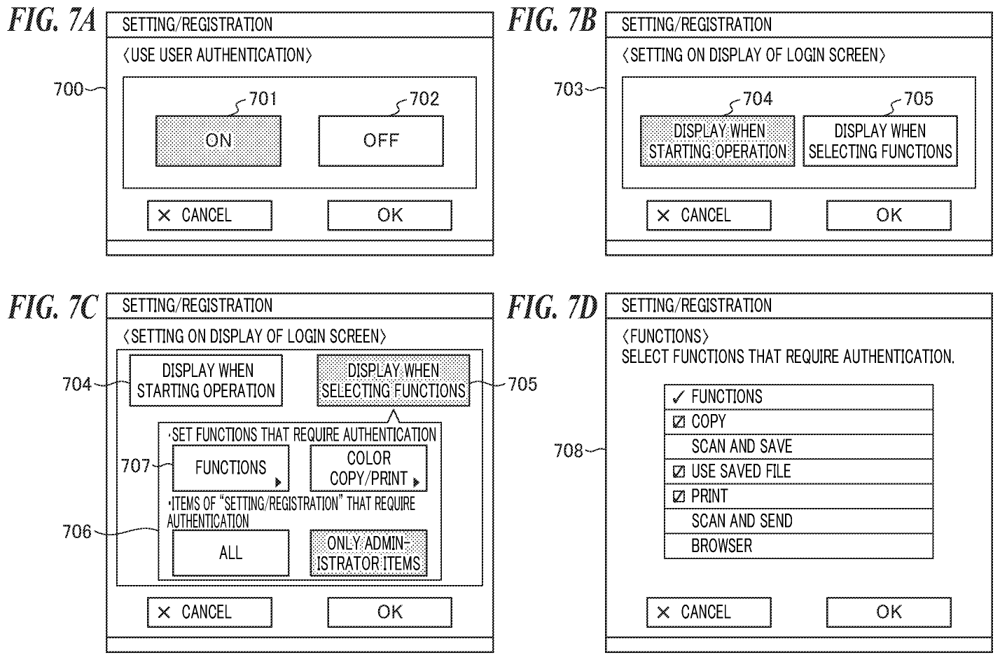

FIGS. 7A to 7D are views showing examples of setting screens which are displayed on the operating unit 206 in FIG. 2. The setting screens in FIGS. 7A to 7D are displayed when an administrator of the MFP 101 has logged in to the MFP 101.

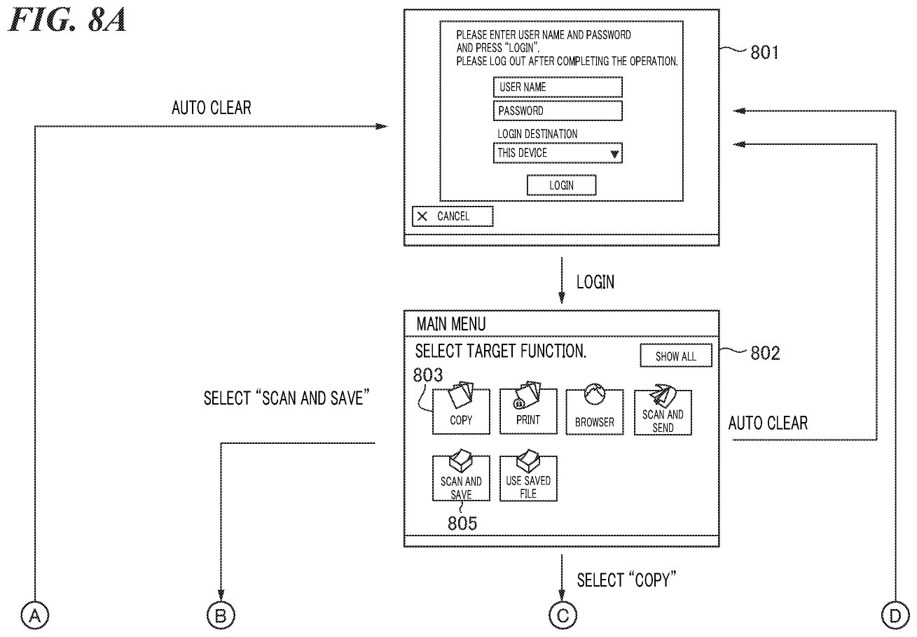

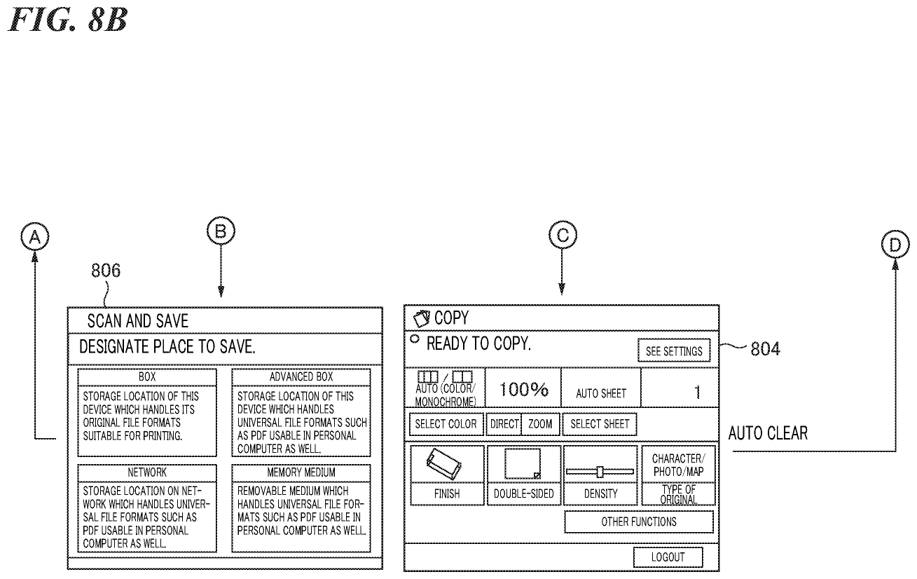

FIG. 7A is a view showing an authentication setting screen 700 for setting whether or not to use user authentication. The authentication setting screen 700 has buttons 701 and 702. The button 701 is for enabling user authentication. When the button 701 is selected, user authentication is required so as to use the functions of the MFP 101. In this case, an authentication screen 801 in FIG. 8A, to be described later, for inputting authentication information is displayed on the operating unit 206 at a time set on a display setting screen 704 in FIG. 7B, to be described later. The button 702 is for disabling user authentication. When the button 702 is selected, user authentication is not required so as to use the functions of the MFP 101, and the authentication screen 801 in FIG. 8A, to be described later, is not displayed on the operating unit 206.

FIG. 7B is a view showing a display setting screen 703 for setting a time at which the authentication screen 801 is displayed. The display setting screen 703 has buttons 704 and 705. The button 704 is for making a setting that will display the authentication screen 801 at the start of operation on the MFP 101. When the button 704 is selected, the authentication screen 801, to be described later, is displayed on the operating unit 206 when the user inputs authentication information for logging in to the MFP 101. The button 705 is for making a setting that will display the authentication screen 801, to be described later, when each function is selected. When the user depresses the button 705, a function selection menu 706 for selecting a function that requires user authentication is displayed as shown in FIG. 7C. When a button 707 is selected on the function selection menu 706, the display on the operating unit 206 switches from the display setting screen 703 to an advanced setting screen 708 in FIG. 7D.

The advanced setting screen 708 is a screen for selecting functions that require user authentication from among the plurality of functions which the MFP 101 has. The MFP 101 requires user authentication when functions selected on the advanced setting screen 708 are used. For example, as shown in FIG. 7D, user authentication is required to use “copy”, “use saved file”, and “print” functions selected on the advanced setting screen 708. On the other hand, the MFP 101 does not require user authentication to use functions that are not selected on the advanced setting screen 708. For example, as shown in FIG. 7D, user authentication is not required to use “scan and save”, “scan and send”, and “browser” functions that are not selected on the advanced setting screen 708. In the MFP 101, the administrator of the MFP 101 configures settings on the signage setting screen 500, the authentication setting screen 700, and the display setting screen 703 in advance and provides control to switch screens on the operating unit 206 based on those settings. A description will now be given of screen transition on the operating unit 206 based on the settings configured on the signage setting screen 500, the authentication setting screen 700, and the display setting screen 703. First, a description will be given of screen transition in a case where the screen display checkbox 501 on the signage setting screen 500 is not selected, that is, a setting that will not display contents on the operating unit 206 is made.

FIGS. 8A and 8B are views useful in explaining screen transition on the operating unit 206 according to a first display setting. The first display setting is a setting that will not display contents on the operating unit 206 and will require user authentication at the start of operation on the MFP 101. Specifically, in the first display setting, the screen display checkbox 501 on the signage setting screen 500 is not selected, and the button 701 on the authentication setting screen 700 and the button 704 on the display setting screen 703 are on.

According to the first display setting, when the user turns on power to the MFP 101, and the MFP 101 is started, the authentication screen 801 is displayed on the operating unit 206 as shown in FIGS. 8A and 8B. The MFP 101 performs user authentication based on authentication information input on the authentication screen 801, and upon completing the login process, the MFP 101 displays a main menu screen 802, which is an initial screen, on the operating unit 206. When the user depresses any of function buttons on the main menu screen 802, the MFP 101 displays a screen corresponding to the selected function button on the operating unit 206. For example, when the user selects a function button 803 corresponding to the copying function on the main menu screen 802, the MFP 101 displays an application screen 804 on the operating unit 206. The application screen 804 is a screen for configuring settings on copying. When the user selects a function button 805 corresponding to the scan and save function on the main menu screen 802, the MFP 101 displays an application screen 806 on the operating unit 206. The application screen 806 is a screen for selecting a location at which scanned-off image data is to be stored. On the other hand, when the auto clear transition time period has elapsed without the user operating the operating unit 206, the MFP 101 carries out the auto clear process. Then, the MFP 101 carries out the logout process and switches the display on the operating unit 206 to the authentication screen 801, not to the main menu screen 802.

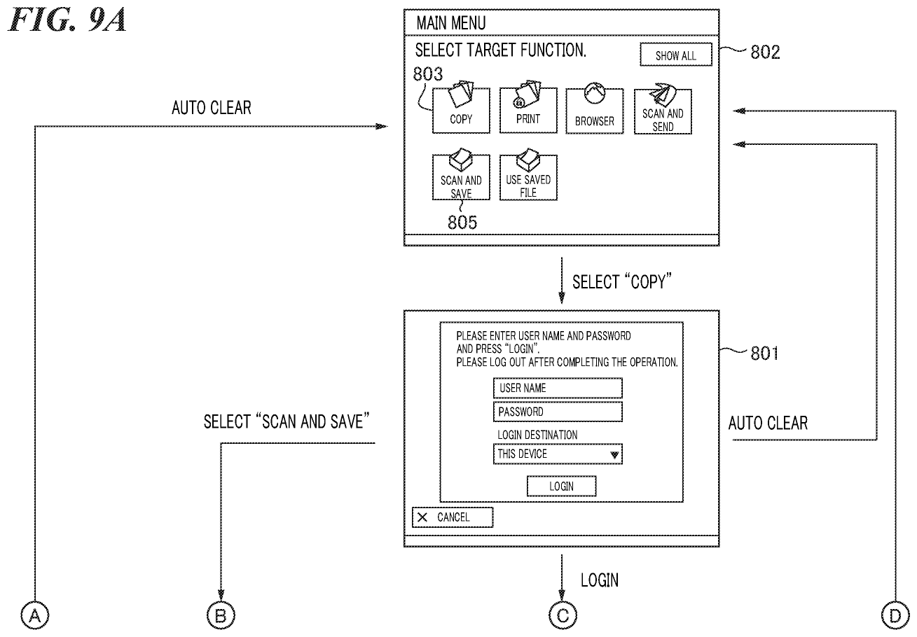

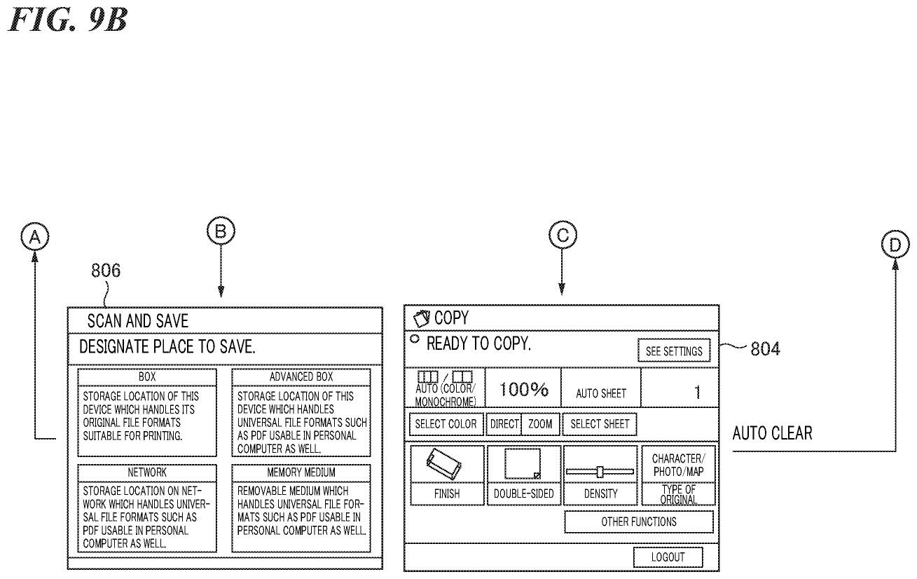

FIGS. 9A and 9B are views useful in explaining screen transition on the operating unit 206 according to a second display setting. The second display setting is a setting that will not display contents on the operating unit 206 and will require user authentication when specific functions are selected. Specifically, in the second display setting, the screen display checkbox 501 on the signage setting screen 500 is not selected, and the button 701 on the authentication setting screen 700 and the button 705 on the display setting screen 703 are on. Also, in the second display setting, “copy”, “use saved file”, and “print” on the advanced setting screen 708 are selected.

According to the second display setting, when the user turns on power to the MFP 101, and the MFP 101 is started, the main menu screen 802, which is the initial screen, is displayed on the operating unit 206. When the user selects a function button corresponding to a function that requires user authentication on the main menu screen 802, the MFP 101 displays the authentication screen 801 on the operating unit 206. For example, when the user selects the function button 803 corresponding to the copying function which is selected on the advanced setting screen 708, the MFP 101 displays the authentication screen 801 on the operating unit 206. When the user inputs authentication information and is successfully authenticated, the MFP 101 displays the application screen 804 on the operating unit 206. On the other hand, when the user selects a function button corresponding to a function that does not require user authentication on the main menu screen 802, the MFP 101 does not display the authentication screen 801 but displays an application screen corresponding to the selected function on the operating unit 206. For example, when the user selects the function button 805 corresponding to “scan and save” which is not selected on the advanced setting screen 708, the MFP 101 displays the application screen 806 on the operating unit 206. When the auto clear transition time period has elapsed without the user operating the operating unit 206, the MFP 101 carries out the auto clear process and also carries out the logout process to switch the display on the operating unit 206 to the main menu screen 802 which is the initial screen.

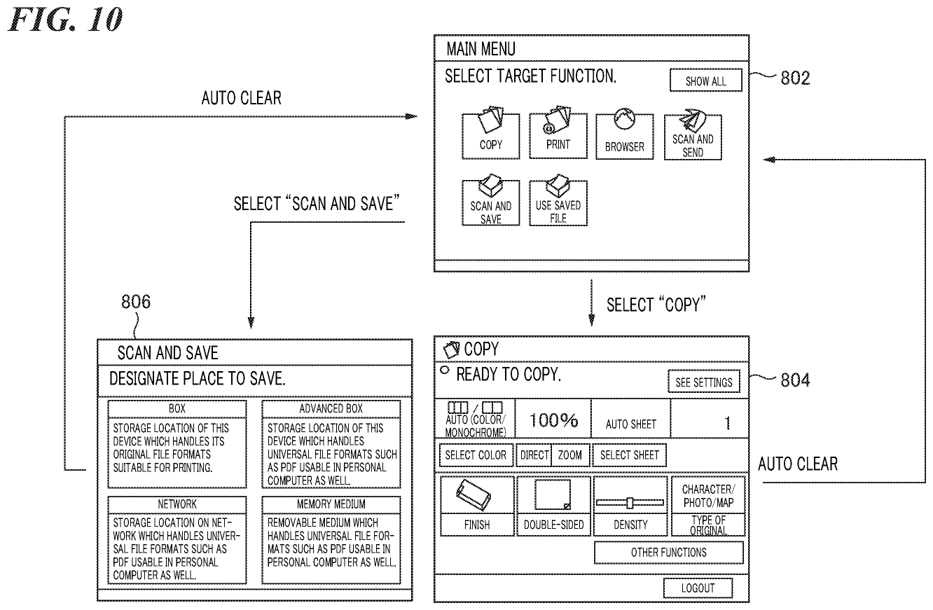

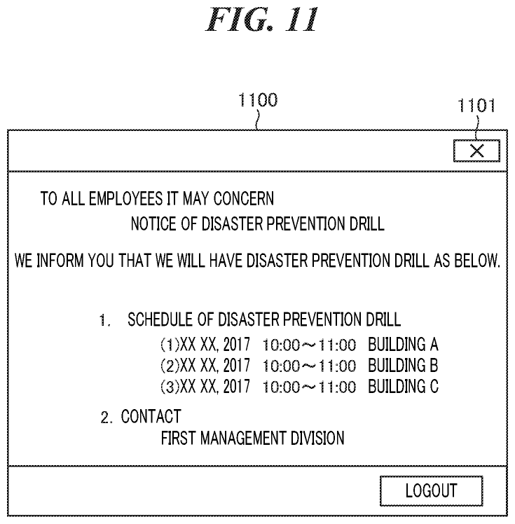

FIG. 10 is a view useful in explaining screen transition on the operating unit 206 according to a third display setting. The third display setting is a setting that will not display contents on the operating unit 206 and will not require user authentication. Specifically, in the third display setting, the screen display checkbox 501 on the signage setting screen 500 is not selected, and the button 702 on the authentication setting screen 700 is on.

According to the third display setting, when the user turns on power to the MFP 101, and the MFP 101 is started, the main menu screen 802, which is the initial screen, is displayed on the operating unit 206. When the user selects a function button on the main menu screen 802, the MFP 101 displays an application screen corresponding to the selected function on the operating unit 206. When the auto clear transition time period has elapsed without the user operating the operating unit 206, the MFP 101 carries out the auto clear process and also carries out the logout process to switch the display on the operating unit 206 to the main menu screen 802 which is the initial screen.

A description will now be given of screen transition in a case where the screen display checkbox 501 on the signage setting screen 500 is selected, that is, a setting that will display contents is made. In this case, the MFP 101 obtains a content, which is set in one of the text boxes 504 and 507, on the signage setting screen 500 from the content server 105 or the HDD 204. The MFP 101 displays the obtained content, for example, the Web content 1100 in FIG. 11 on the operating unit 206. When the user depresses a close button 1101, the Web content 1100 is hidden. The Web content 1100 shows information provided to the user who uses the MFP 101, for example, a notice of a disaster prevention drill. Thus, in the present embodiment, notices to employees are registered as contents, and they are displayed on the operating unit 206 using the signage application 305 to, for example, easily support sharing of information among the employees and control of information in companies.

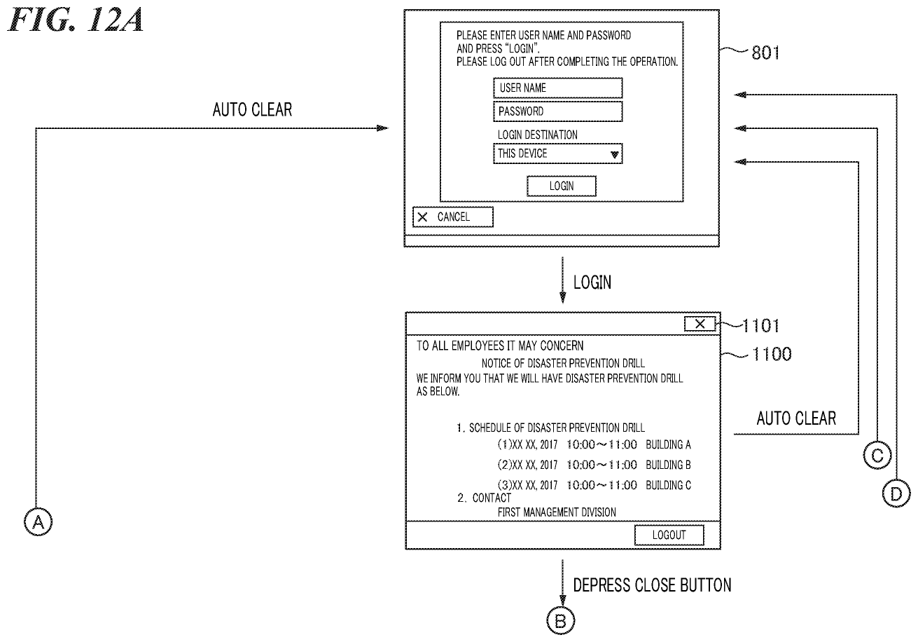

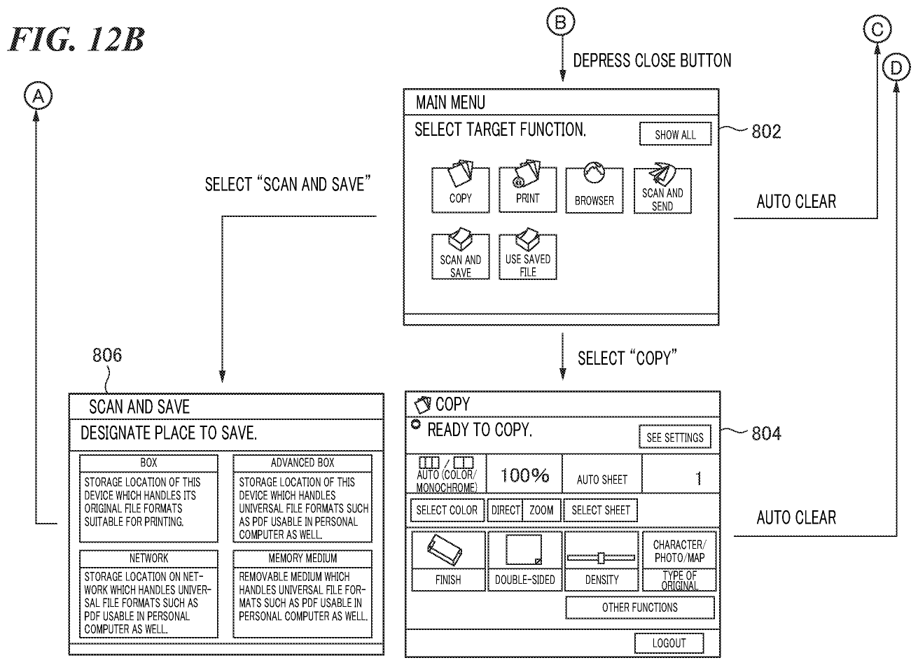

FIGS. 12A and 12B are views useful in explaining screen transition on the operating unit 206 according to a fourth display setting. The fourth display setting is a setting that will display contents on the operating unit 206 after login. Specifically, in the second display setting, the screen display checkbox 501 and the display timing setting button 512 on the signage setting screen 500 are selected. In the fourth display setting, the same settings are configured on the authentication setting screen 700 and the display setting screen 703 as those in the first display setting.

According to the fourth display setting, when the user turns on power to the MFP 101, and the MFP 101 is started, the authentication screen 801 is displayed on the operating unit 206 as with FIGS. 8A and 8B. Upon completing the login process, the MFP 101 performs user authentication based on authentication information input on the authentication screen 801. The MFP 101 displays a content, which is set in one of the text boxes 504 and 507, for example, the Web content 1100 on the operating unit 206. Thus, in the present embodiment, the user who has been successfully authenticated is notified of a variety of information such as a notice of a disaster prevention drill. When the user depresses the close button 1101, the MFP 101 displays the main menu screen 802, which is the initial screen, on the operating unit 206.

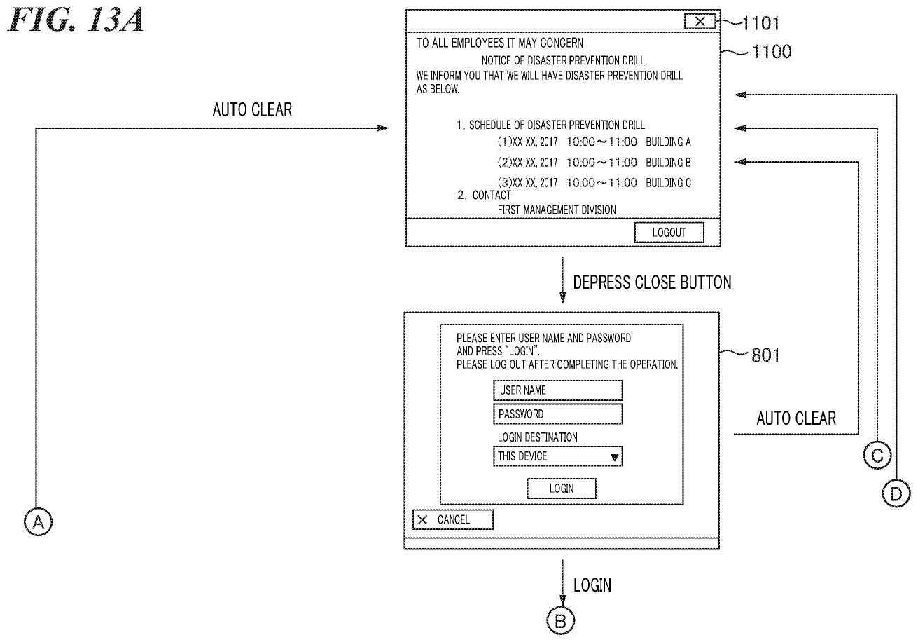

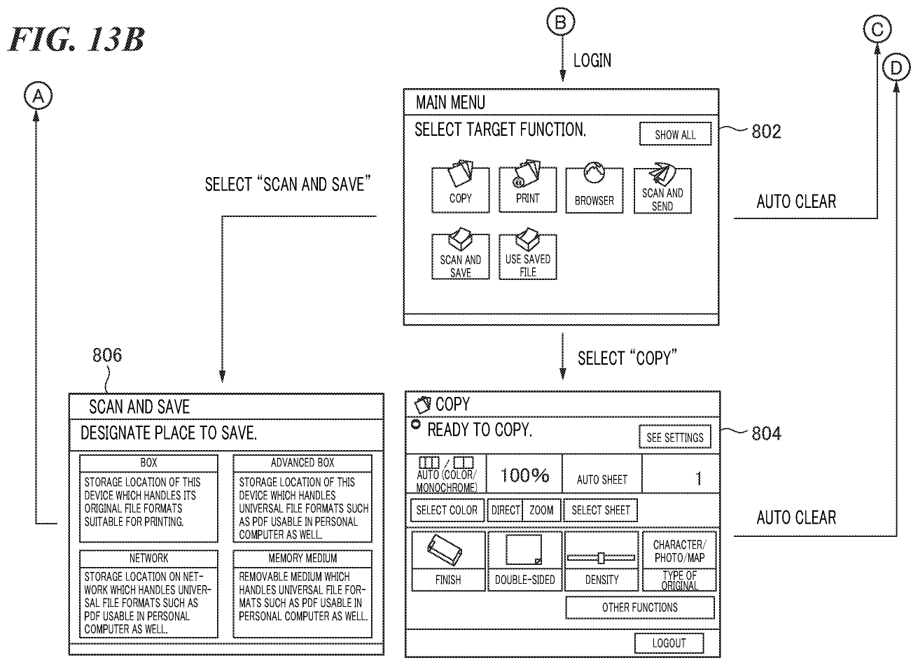

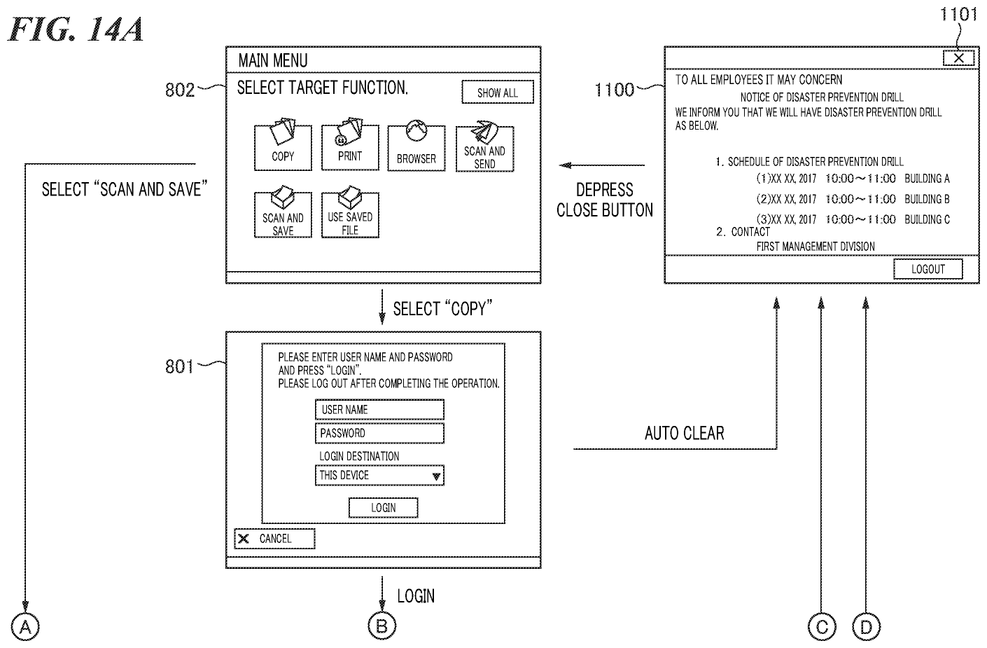

FIGS. 13A and 13B are views useful in explaining screen transition on the operating unit 206 according to a fifth display setting. The fifth display setting is a setting that will display contents on the operating unit 206 after auto clear. Specifically, in the fifth display setting, the screen display checkbox 501 and the display timing setting button 512 on the signage setting screen 500 are selected. In the fifth display setting, the same settings are configured on the authentication setting screen 700 and the display setting screen 703 as those in the first display setting.

According to the fifth display setting, when the auto clear transition time period has elapsed without the user logged in to the MFP 101 operating the operating unit 206, the MFP 101 carries out the auto clear process and also carries out the logout process. Then, the MFP 101 displays the Web content 1100 on the operating unit 206. According to the fifth display setting, the Web content 1100 is displayed on the operating unit 206 as long as the auto clear process has been carried out whichever of the authentication screen 801, the main menu screen 802, and the application screens 804 and 806 is being displayed on the operating unit 206. Namely, according to the present embodiment, in a situation where it is quite likely that the user who had used the MFP 101 has left the MFP 101 because, for example, the auto clear transition time period has elapsed without the MFP 101 being operated, a user who moves past the MFP 101 and another user who uses the MFP 101 next are notified of a variety of information such as a notice of a disaster prevention drill. When the user depresses the close button 1101 in the Web content 1100, the MFP 101 displays the authentication screen 801 on the operating unit 206.

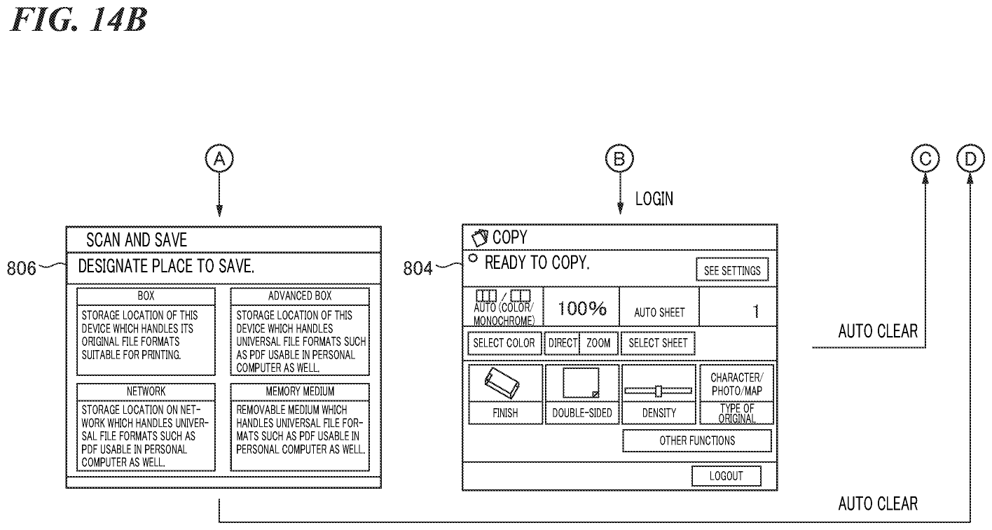

FIGS. 14A and 14B are views useful in explaining screen transition on the operating unit 206 according to a sixth display setting. The sixth display setting is a setting that will display contents on the operating unit 206 after auto clear and will require user authentication when specific functions are selected. Specifically, in the sixth display setting, the screen display checkbox 501 on the signage setting screen 500 is selected. In the sixth display setting, the same settings are configured on the authentication setting screen 700 and the display setting screen 703 as those in the second display setting.

According to the sixth display setting, when the MFP 101 has not carried out the auto clear process, it performs the same screen transition as the second display setting. On the other hand, when the MFP 101 has carried out the auto clear process, it displays the Web content 1100 on the operating unit 206. When the user depresses the close button 1101 in the Web content 1100, the MFP 101 displays the main menu screen 802, which is the initial screen, on the operating unit 206.

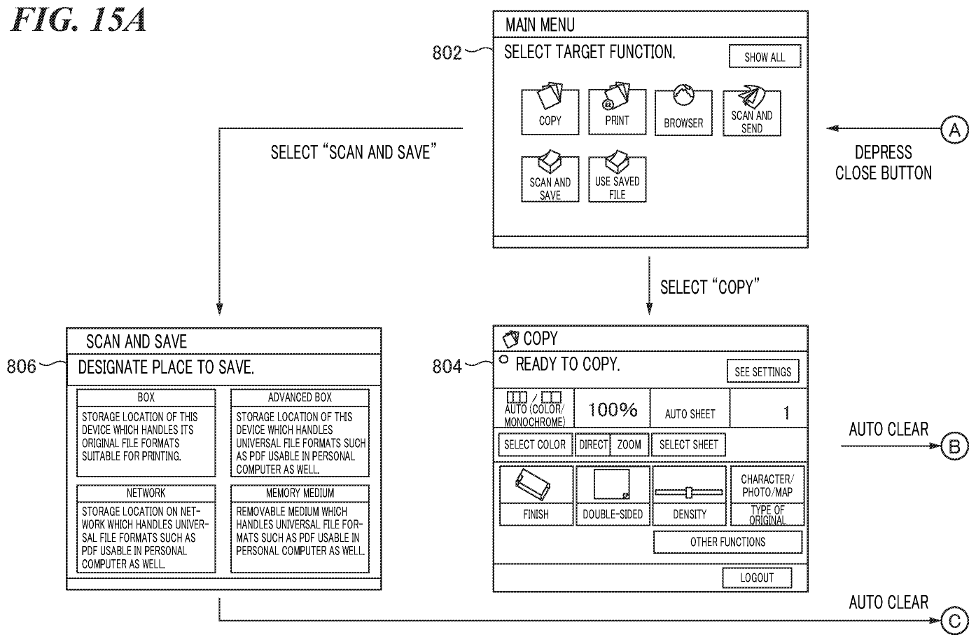

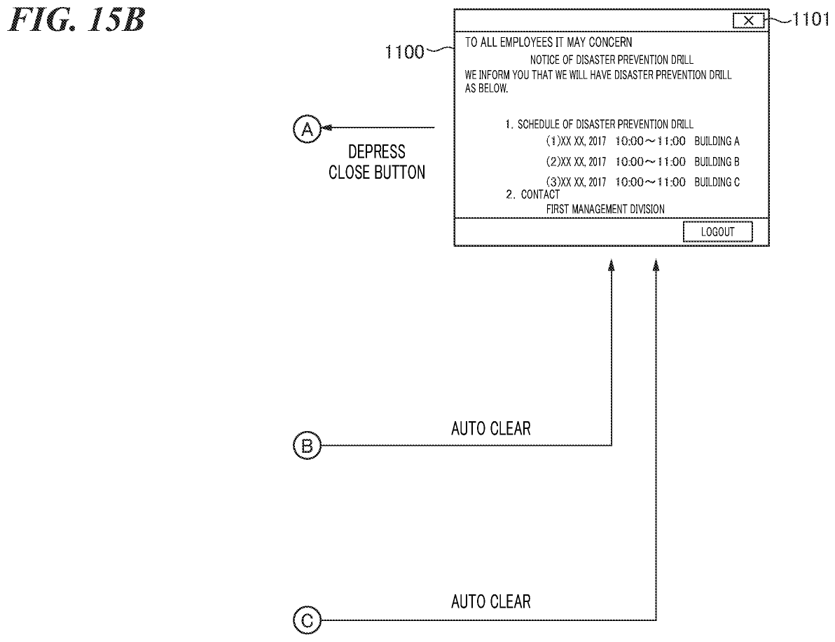

FIGS. 15A and 15B are views useful in explaining screen transition on the operating unit 206 according to a seventh display setting. The seventh display setting is a setting that will display contents on the operating unit 206 after auto clear and will not require user authentication. Specifically, in the seventh display setting, the screen display checkbox 501 on the signage setting screen 500 is selected. In the seventh display setting, the same settings are configured on the authentication setting screen 700 as those in the third display setting.

According to the seventh display setting, when the MFP 101 has not carried out the auto clear process, it performs the same screen transition as the third display setting. On the other hand, when the MFP 101 has carried out the auto clear process, it displays the Web content 1100 on the operating unit 206. When the user depresses the close button 1101 in the Web content 1100, the MFP 101 displays the main menu screen 802, which is the initial screen, on the operating unit 206.

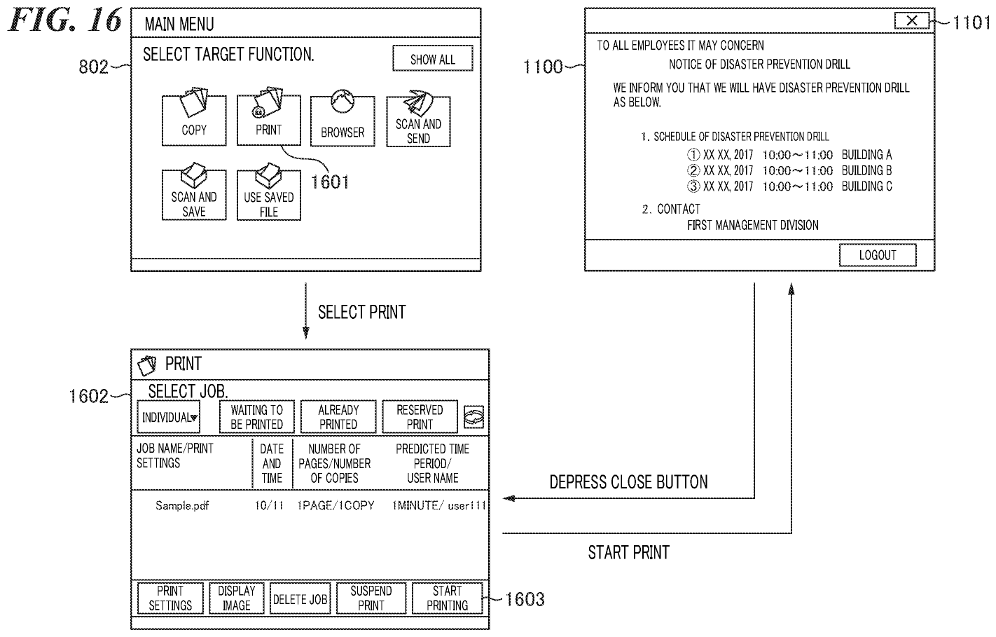

FIG. 16 is a view useful in explaining screen transition on the operating unit 206 according to an eighth display setting. The eighth display setting is a setting that will display contents on the operating unit 206 when printing is being performed. Specifically, in the eighth display setting, the screen display checkbox 501 and the checkbox 514 on the signage setting screen 500 are selected.

According to the eighth display setting, when the user depresses a function button 1601 in FIG. 16 corresponding to the printing function on the main menu screen 802, the MFP 101 displays an application screen 1602 in FIG. 16 on the operating unit 206. The application screen 1602 is a screen for configuring settings on the printing function. When the user selects a print start button 1603 on the application screen 1602, the MFP 101 starts printing and also switches the display on the operating unit 206 from the application screen 1602 to the Web content 1100. After that, when the printing is completed or when the user depresses the close button 1101, the MFP 101 switches the display on the operating unit 206 from the Web content 1100 to the application screen 1602. It should be noted that in the present embodiment, the MFP 101 does not display the Web content 1100 on the operating unit 206 when it has received a print job starting instruction in a way using the operating unit 206, for example, from an external apparatus such as the client PC 104.

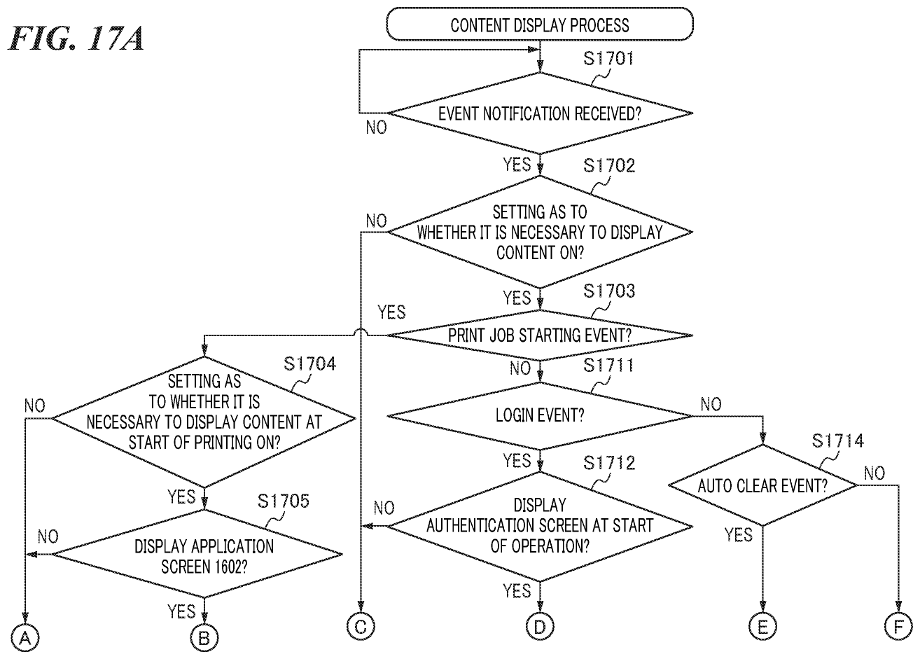

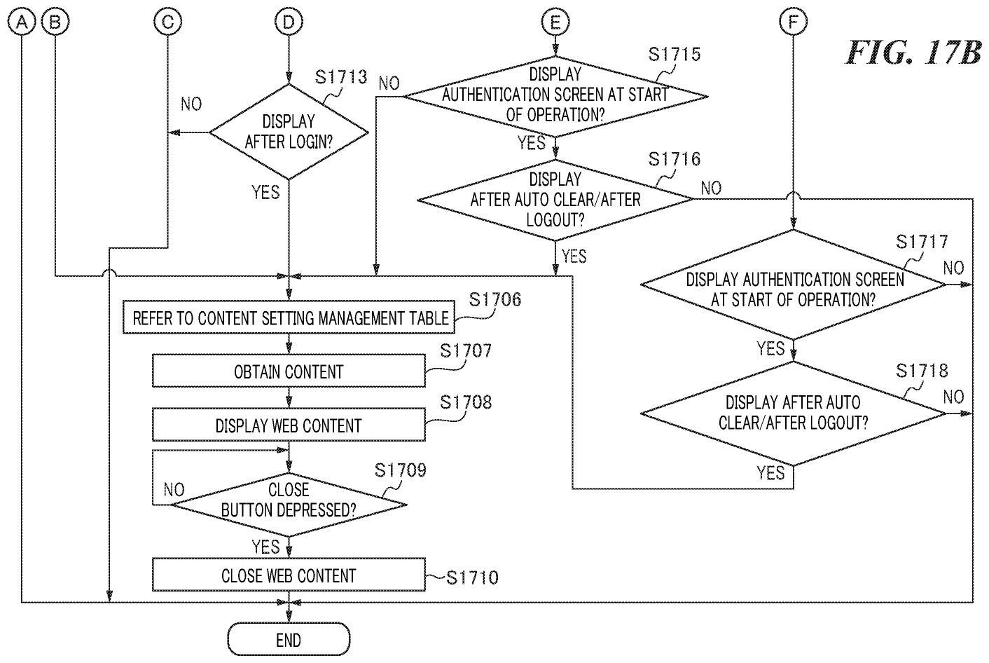

FIGS. 17A and 17B are flowcharts showing the procedure of a content display process which is carried out by the MFP 101 in FIG. 1. The process in FIGS. 17A and 17B are implemented by the CPU 201 executing a program stored in the ROM 202 or the HDD 204.

Referring to FIGS. 17A and 17B, first, the CPU 201 determines whether or not an event notification indicating occurrence of a specific event relating to operation on the operating unit 206 by the user has been received by the event receiving module 311 (step S1701). When the event receiving module 311 has received any event notification from the authentication process module 313, the auto clear process module 314, and the print management module 315, the CPU 201 determines that the event notification indicating occurrence of the specific event has been received. The authentication process module 313 sends an event notification indicating occurrence of a login event which is for the user to log in to the MFP 101 using the operating unit 206. The authentication process module 313 sends an event notification indicating occurrence of a logout event which is for the user to log out of the MFP 101 using the operating unit 206. The auto clear process module 314 sends an event notification indicating occurrence of an auto clear event for carrying out the auto clear process in response to the auto clear time period having elapsed without the user operating the operating unit 206. The auto clear process module 314 sends an event notification indicating occurrence of a logout event for carrying out the logout process in response to the auto clear process having been carried out. The print management module 315 sends an event notification indicating occurrence of a print job starting event for starting execution of a print job in response to an instruction received via the operating unit 206.

Upon receiving the event notification indicating occurrence of the specific event (YES in the step S1701), the CPU 201 obtains a setting as to whether or not it is necessary to display contents from the content setting management table 310. Specifically, the CPU 201 obtains a setting value indicating whether or not the screen display checkbox 501 on the signage setting screen 500 is selected as the setting as to whether or not it is necessary to display contents. Then, the CPU 201 determines whether or not the screen display checkbox 501 is selected, that is, the setting as to whether or not it is necessary to display contents is on (step S1702).

As a result of the determination in the step S1702, the screen display checkbox 501 is not selected, that is, the setting as to whether or not it is necessary to display contents is off, the CPU 201 ends the present process. As a result of the determination in the step S1702, the setting as to whether or not it is necessary to display contents is on, the CPU 201 determines whether or not the received event notification indicates the print job starting event (step S1703).

As a result of the determination in the step S1703, the received event notification indicates the print job starting event, the CPU 201 obtains a setting as to whether or not it is necessary to display contents at the start of printing from the content setting management table 310. Specifically, the CPU 201 obtains a setting value indicating whether or not the checkbox 514 on the signage setting screen 500 is selected as the setting as to whether or not it is necessary to display contents at the start of printing. The CPU 201 then determines whether or not the checkbox 514 is selected, that is, the setting as to whether or not it is necessary to display contents at the start of printing is on (step S1704).

As a result of the determination in the step S1704, the checkbox 514 is not selected, that is, the setting as to whether or not it is necessary to display contents at the start of printing is off, the CPU 201 ends the present process. As a result of the determination in the step S1704, the setting as to whether or not it is necessary to display contents at the start of printing is on, the CPU 201 determines whether or not the application screen 1602 is displayed on the operating unit 206 (step S1705).

As a result of the determination in the step S1705, when the application screen 1602 is not displayed on the operating unit 206, the CPU 201 ends the present process. As a result of the determination in the step S1705, when the application screen 1602 is displayed on the operating unit 206, the CPU 201 refers to the content setting management table 310 (step S1706). Then, the CPU 201 obtains a content path from the content setting management table 310 and notifies the content display module 307 of the obtained content path. After that, the CPU 201 causes the content display module 307 to obtain a content indicated by the content path from the content server 105 (step S1707) and writes the obtained content into the RAM 203. Then, the CPU 201 causes the content display module 307 of the signage application 305 to display the obtained content, for example, the Web content 1100 on the operating unit 206 (step S1708) (see, for example, FIG. 16).

After that, when the user depresses the close button 1101 on the Web content 1100 (YES in step S1709), the CPU 201 closes the Web content 1100 (step S1710). The CPU 201 then ends the present process.

As a result of the determination in the step S1703, when the received event notification does not indicate the print job starting event, the CPU 201 determines whether or not the received event notification indicates the login event (step S1711).

As a result of the determination in the step S1711, when the received event notification indicates the login event, the CPU 201 determines whether or not a setting that will display the authentication screen 801 at the start of operation is made on the display setting screen 703 (step S1712).

As a result of the determination in the step S1712, when the setting that will display the authentication screen 801 at the start of operation is not made on the display setting screen 703, the CPU 201 ends the present process. As a result of the determination in the step S1712, when the setting that will display the authentication screen 801 at the start of operation is made on the display setting screen 703, the CPU 201 obtains a setting value relating to a content display time from the content setting management table 310. Specifically, the CPU 201 obtains a setting value indicating which one of the display timing setting buttons 512 and 513 on the signage setting screen 500 is selected as the setting value relating to the content display time. Then, the CPU 201 determines whether or not the content display time is after login (step S1713). In the step S1713, when the display timing setting button 512 on the signage setting screen 500 is selected, the CPU 201 determines that the content display time is after login. On the other hand, when the display timing setting button 512 on the signage setting screen 500 is not selected, the CPU 201 determines that the content display time is not after login.

As a result of the determination in the step S1713, when the content display time is not after login, the CPU 201 ends the present process. As a result of the determination in the step S1713, when the content display time is after login, the CPU 201 carries out the processes in the step S1706 and the subsequent steps (see, for example, FIGS. 12A and 12B).

As a result of the determination in the step S1711, when the received event notification does not indicate the login event, the CPU 201 determines whether or not the received event notification indicates the auto clear event (step S1714).

As a result of the determination in the step S1714, when the received event notification indicates the auto clear event, the CPU 201 determines whether or not a setting that will display the authentication screen 801 at the start of operation is made on the display setting screen 703 (step S1715).

As a result of the determination in the step S1715, when the setting that will display the authentication screen 801 at the start of operation is made on the display setting screen 703, the CPU 201 obtains a setting value relating to a content display time from the content setting management table 310. Then, the CPU 201 determines whether or not the content display time is after auto clear/after logout (step S1716).

As a result of the determination in the step S1716, when the content display time is not after auto clear/after logout, the CPU 201 ends the present process. As a result of the determination in the step S1716, when the content display time is after auto clear/after logout, the CPU 201 carries out the processes in the step S1706 and the subsequent steps (see, for example, FIGS. 13A and 13B).

As a result of the determination in the step S1715, when the setting that will display the authentication screen 801 at the start of operation is not made on the display setting screen 703, the CPU 201 carries out the processes in the step S1706 and the subsequent steps (see, for example, FIGS. 14 and 15). The case where the setting that will display the authentication screen 801 at the start of operation is not made on the display setting screen 703 corresponds to, for example, a case where a setting that will display the authentication screen 801 when specific functions are selected on the display setting screen 703 or a case where the button 702 is selected on the authentication setting screen 700.

As a result of the determination in the step S1714, the received event notification does not indicate the auto clear event, the CPU 201 determines that the received event notification indicates the logout event. The CPU 201 determines whether or not a setting that will display the authentication screen 801 at the start of operation is made on the display setting screen 703 (step S1717).

As a result of the determination in the step S1717, when the setting that will display the authentication screen 801 at the start of operation is not made on the display setting screen 703, the CPU 201 ends the present process. As a result of the determination in the step S1717, when the setting that will display the authentication screen 801 at the start of operation is made on the display setting screen 703, the CPU 201 determines whether or not the content display time is after auto clear/after logout (step S1718).

As a result of the determination in the step S1718, when the content display time is not after auto clear/after logout, the CPU 201 ends the present process. As a result of the determination in the step S1718, when the content display time is after auto clear/after logout, the CPU 201 carries out the processes in the step S1706 and the subsequent steps.

According to the embodiment described above, when a specific event relating to operation on the operating unit 206 by the user occurs, the Web content 1100 is displayed on the operating unit 206 of the MFP 101. This provides the user who directly operates the MFP 101 with the Web content 1100 and hence effectively uses waiting time of the user who directly operates the MFP 101.

Moreover, in the embodiment described above, the specific event includes the print job starting event in which execution of a print job is started in response to an instruction received via the operating unit 206. This effectively uses waiting time of the user who has issued an instruction to execute the print job using the operating unit 206.

Furthermore, in the embodiment described above, the specific event includes the login event in which the user logs in to the MFP 101 using the operating unit 206. This reliably notifies the user who has logged in to the MFP 101 using the operating unit 206 of a variety of information such as a notice of a disaster prevention drill.

In the embodiment described above, the specific event includes the logout event and an auto clear event. This notifies the user who has moved past the MFP 101 and the user who uses the MFP 101 next time of a variety of information such as a notice of a disaster prevention drill.

Although the present invention has been described by way of the embodiment, the present invention is not limited to the embodiment described above. For example, contents to be displayed on the operating unit 206 may be switched according to types of specific events that have occurred. For example, in a case where it is quite likely that a logged-in user has left the MFP 101, and a content displayed on the operating unit 206 will not be viewed like the logout event or the auto clear event, the MFP 101 displays a content with a relatively low urgency level of notification on the operating unit 101. On the other hand, in a case where it is very likely that a user who is operating the MFP 10 will view a content displayed on the operating unit 206 like the login event or the print starting event, the MFP 101 displays a content with a relatively high urgency level of notification on the operating unit 101. This enables an appropriate content to be displayed on the operating unit 206 according to an expectation that a content displayed on the operating unit 206 will be viewed.

In the embodiment described above, when a print job is received, a predicted printing time required to execute the print job may be calculated, and based on the calculated predicted printing time period, whether or not to display the Web content 1100 on the operating unit 206 may be determined.

For example, in the process in FIGS. 17A and 17B described above, even in a case where a print job with a short printing time period is executed, the Web content 1100 is displayed on the operating unit 206. In this case, the Web content 1100 is displayed on the operating unit 206 only for a short time period during which the print job is executed, and the Web content 1100 is hidden before the user sees all of the Web content 1100. This confuses the user instead of effectively using waiting time of the user.

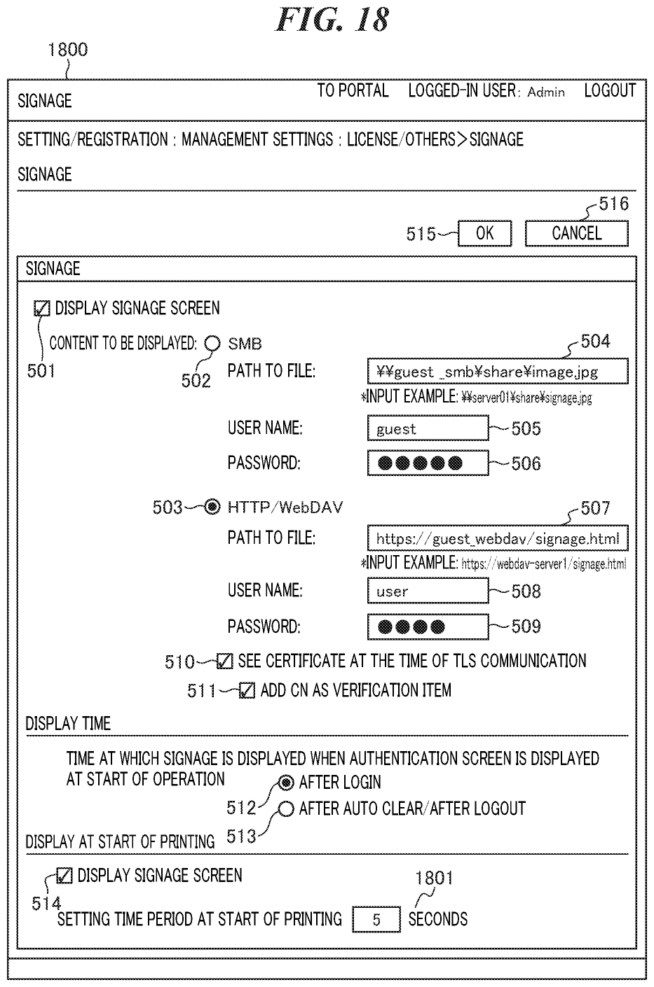

To cope with this problem, in the present embodiment, when the predicted printing time period is equal to or longer than a reference time period, to be described later, set on a signage setting screen 1800 in FIG. 18, the Web content 1100 is displayed on the operating unit 206.

FIG. 18 is a view showing an example of the signage setting screen 1800 which is displayed on the client PC 104 in FIG. 1. The signage setting screen 1800 has a setting time period 1801 as well as the setting items in FIG. 5. A reference time period for use in determining whether or not to display the Web content 1100 on the operating unit 206 based on the calculated predicted printing time period is set as the setting time period 1801. When the calculated predicted printing time period is equal to or longer than the reference time period, the MFP 101 displays the Web content 1100 on the operating unit 206. On the other hand, when the calculated predicted printing time period is shorter than the reference time period, the MFP 101 does not display the Web content 1100 on the operating unit 206. It should be noted that in the present embodiment, all users who use the MFP 101 may share the reference time period set as the setting time period 1801. Moreover, in the present embodiment, different reference time periods may be set for respective users.

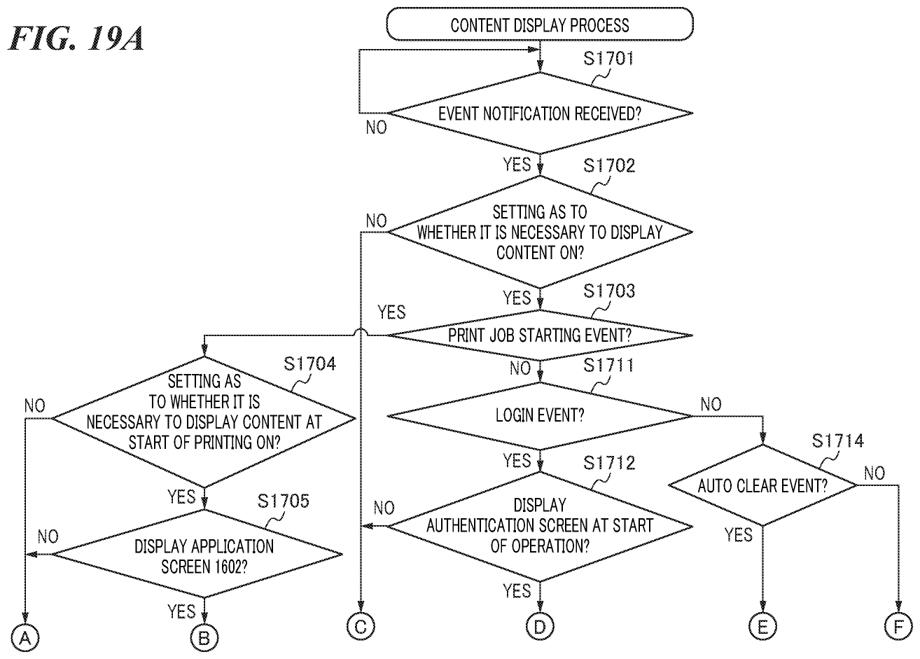

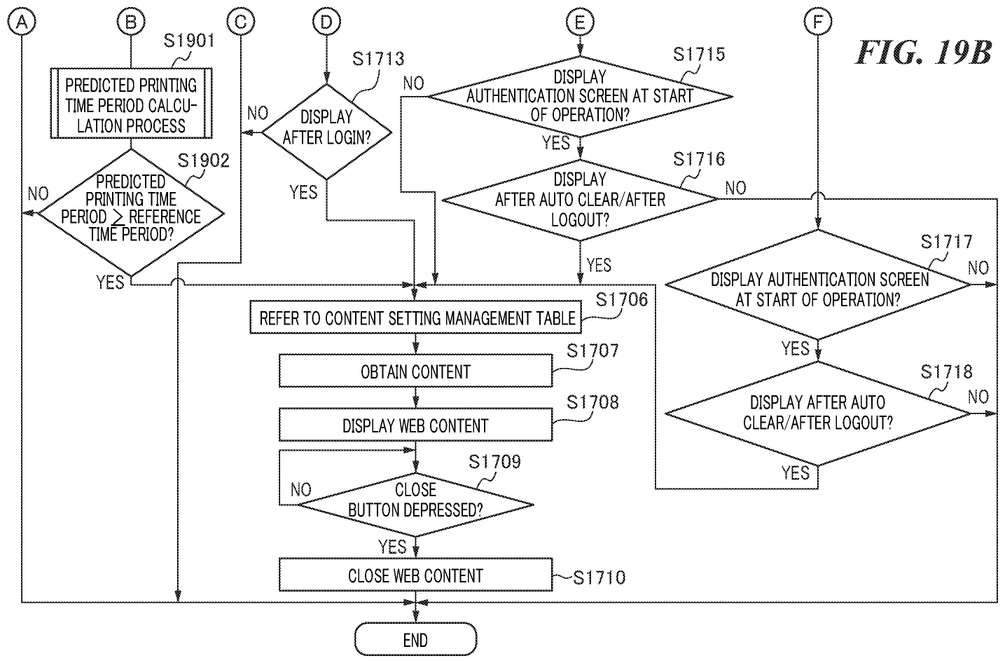

FIGS. 19A and 19B are flowcharts showing the procedure of a variation of the content display process in FIGS. 17A and 17B. The process in FIGS. 19A and 19B are also implemented by the CPU 201 executing a program stored in the ROM 202 or the HDD 204. In the process in FIGS. 19A and 19B, it is assumed that the reference time period has already been set as the setting time period 1801 on the signage setting screen 1800.

Referring to FIGS. 19A and 19B, the CPU 201 carries out the processes in the steps S1701 to S1703. As a result of the determination in the step S1703, the received event notification indicates the print job starting event, the CPU 201 carries out the processes in the steps S1704 and S1705.

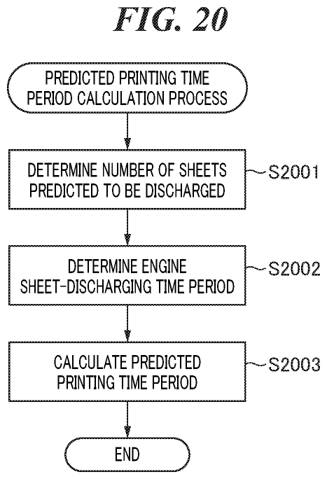

As a result of the determination in the step S1705, when the application screen 1602 is not displayed on the operating unit 206, the CPU 201 ends the present process. As a result of the determination in the step S1705, when the application screen 1602 is displayed on the operating unit 206, the CPU 201 carries out a predicted printing time period calculation process in FIG. 20, to be described later (step S1901). In the step S1901, the CPU 201 calculates a predicted printing time period required to execute a print job indicated by the received event notification. The CPU 201 determines whether or not the predicted printing time period is equal to or longer than the reference time period (step S1902).

As a result of the determination in the step S1902, when the predicted printing time period is equal to or longer than the reference time period, the CPU 201 carries out the processes in the step S1706 and the subsequent steps. As a result of the determination in the step S1902, when the predicted printing time period is shorter than the reference time period, the CPU 201 ends the present process.

FIG. 20 is a flowchart showing the procedure of the predicted printing time period calculation process in the step S1901 in FIGS. 19A and 19B.

Referring to FIG. 20, the CPU 201 determines the number of sheets predicted to be discharged based on setting values relating to the number of copies, the number of originals, cover/interleaved sheet setting, stitching, and so forth (step S2001). The CPU 201 then determines an engine sheet-discharging time period based on setting values relating to a size, double-sided printing, sheet type, sheet-feeding cassette (manual feeding), and so forth set on the application screen 1602 (step S2002). The engine sheet-discharging time period is a value indicating the number of sheets that can be printed per minute by the MFP 101 and is expressed in a unit called PPM. For example, when the PPM of the MFP 101 is 60 PPM, the MFP 101 is able to print 60 sheets per minute. Then, the CPU 201 calculates the predicted printing time period based on the number of sheets predicted to be discharged and the engine sheet-discharging time period (step S2003). In the step S2003, the predicted printing time period is calculated using the following formula, the number of sheets predicted to be discharged÷the engine sheet-discharging time period. After that, the CPU 201 ends the present process and carries out the processes in the step S1902 and the subsequent steps.

In the embodiment described above, when the predicted printing time period is equal to or longer than the reference time period, the Web content 1100 is displayed on the operating unit 206. This makes it possible to display the Web content 1100 on the operating unit 206 when a certain period of time required for the user to see the Web content 1100 can be secured. This prevents the user from being confused due to the Web content 1100 being displayed for an excessively short time period.

In the embodiment described above, the predicted printing time period may include a predicted time period required for a finishing process such as stapling, punching, and folding to be performed on printed matter generated by the printer 208.

Although in the embodiment described above, the MFP 101 is equipped with a plurality of functions such as the copying function and the scanner function, the MFP 101 may be equipped with only some of the plurality of functions.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as ‘anon-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™, a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-093116, filed May 14, 2018, which is hereby incorporated by reference herein in its entirety.

What is claimed is:

1. An image forming apparatus equipped with a display unit and an operating unit, comprising:
an obtaining unit configured to obtain a content registered in advance; and
a display control unit configured to provide control to display the content on the display unit,
wherein the display control unit displays the content on the display unit when a specific event relating to operation on the operating unit by a user has occurred.

2. The image forming apparatus according to claim 1, wherein the specific event includes an event associated with a job relating to image formation.

3. The image forming apparatus according to claim 2, wherein the event associated with the job relating to image formation is a print starting event for starting execution of a print job in response to an instruction received by the operating unit.

4. The image forming apparatus according to claim 3, further comprising:
a printing unit; and
a predicted printing time period calculation unit configured to calculate a predicted time period required to perform printing by the printing unit,
wherein the display control unit displays the content on the display unit when the predicted time period is equal to or longer than a predetermined time period set in advance.

5. The image forming apparatus according to claim 4, wherein the predicted time period includes a predicted time period required to carry out a finishing process on printed matter generated by the printing unit.

6. The image forming apparatus according to claim 1, wherein the specific event includes a login event that is for the user to log in to the image forming apparatus using the operating unit.

7. The image forming apparatus according to claim 1, wherein the specific event includes a logout event that is for the user to log out the image forming apparatus and an auto clear event for carrying out an auto clear process in which a setting state of a screen displayed on the image forming apparatus is reset in response to a predetermined time period having elapsed without the user operating the operating unit.

8. The image forming apparatus according to claim 1, wherein the display control unit switches the content to be displayed on the display unit according to a type of the specific event that has occurred.

9. The image forming apparatus according to claim 1, comprising:
a first operating environment for running software modules incorporated in advance in the image forming apparatus; and
a second operating environment for running the software modules incorporated in advance in the image forming apparatus and expansion application modules installed in the image forming apparatus,
wherein upon receiving an instruction to start printing is received by an instruction receiving application running in the second operating environment, the instruction receiving application requests a print management module, which runs in the first operating environment and manages an operation to start printing, to perform printing,
upon receiving the print request, the print management module performs the operation to start printing and also requests a content display control application, which runs in the second operating environment, to display the content, and
upon receiving the display request, the content display control application provides control to display the content on the display unit.

10. A control method for an image forming apparatus equipped with a display unit and an operating unit, comprising:
an obtaining step of obtaining a content registered in advance; and
a display control step of providing control to display the content on the display unit,
wherein in the display control step, the content is displayed on the display unit when a specific event relating to operation on the operating unit by a user has occurred.

11. A non-transitory computer-readable storage medium storing a program for causing a computer to execute a control method for an image forming apparatus equipped with a display unit and an operating unit, the control method for the image forming apparatus comprising:
an obtaining step of obtaining a content registered in advance; and
a display control step of providing control to display the content on the display unit,
wherein in the display control step, the content is displayed on the display unit when a specific event relating to operation on the operating unit by a user has occurred.
